(19) United States
(12) Patent Application Publication
(10) Pub. No.: US 2012/0024784 A1
(43) Pub. Date: Feb. 2, 2012

(54) Fluid Gasification/Degasification Apparatuses, Systems, and Processes

(76) Inventors: Christopher Clark, Madeira Beach, FL (US); Joseph Bonazza, Tarentum, PA (US); Navin Kadakia, Bridgeville, PA (US); Peter Ritchey, Mount Lebanon, PA (US); Richard Dennis, Wesley Chapel, FL (US)

(21) Appl. No.: 13/105,149

(22) Filed: May 11, 2011

Related U.S. Application Data
(60) Provisional application No. 61/369,146, filed on Jul. 30, 2010.

(51) Int. Cl. C02F 1/20; C02F 1/44; C02F 1/66; B01D 69/08; B01D 61/00

(52) U.S. Cl. 210/638; 210/151; 210/137; 210/88

(57) ABSTRACT

Apparatuses, systems and processes for fluid gasification and degasification are disclosed. A fluid gasification/degasification apparatus includes housing having a central axis and at least one fluid inlet and at least one fluid outlet positioned at different axial locations along the housing. A membrane unit that includes a plurality of bundled microporous hollow membrane strands is disposed within the housing and extends in parallel to the central axis of the housing. The fluid gasification/degasification apparatus further includes one or more gas addition/removal apparatuses for facilitating at least one of: a gas addition operation and a gas removal operation. An orientation of the fluid inlet(s) and fluid outlet(s) results in a substantial portion of a carrier fluid introduced to the housing traveling in parallel along exterior surfaces of the membrane unit thereby allowing for an extended interface time between the carrier fluid and micro-bubbles of a gas supplied to the membrane unit.

### CROSS-REFERENCE TO RELATED APPLICATIONS

This application claims priority under 35 U.S.C. §119(e) to U.S. Provisional Application Ser. No. 61/369,146 filed on Jul. 30, 2010, the disclosure of which is hereby incorporated by reference in its entirety.

### BACKGROUND

Wastewater—which may include any water that has been adversely affected in quality by anthropogenic influence—is typically subjected to various physical, biological, and chemical treatment processes in order to eliminate or significantly reduce various contaminants present therein, including potentially pathogenic microorganisms and/or harmful chemicals. Wastewater subjected to such treatment processes often must be further treated in order to render it suitable for consumption as drinking water. For example, treatment processes may be performed within basic pH ranges, requiring a lowering of the pH to within an acceptable range for human consumption.

The dissolution of acids in a solution can lower the pH of the solution by increasing the concentration of hydronium ions present therein. Acidic compounds may directly dissolve in solution while non-acidic compounds may react with other species present in the solution to form acidic products that lower the solution pH.

### SUMMARY

Apparatuses, systems and processes for the gasification and/or degasification of a fluid are disclosed. Apparatuses and systems according to embodiments of the invention yield significant advantages over conventional apparatuses and systems, and may be used to chemically alter a fluid stream. For example, apparatuses and systems according to embodiments of the invention may be used to precisely adjust the pH of a fluid stream.

In accordance with one or more embodiments of the invention, a fluid gasification/degasification apparatus comprises housing comprising a vertically aligned central axis that extends between a top portion and a bottom portion of the housing and at least one fluid inlet and at least one fluid outlet positioned at different axial locations along the housing; a membrane unit disposed within the housing and comprising a plurality of bundled microporous hollow fiber membrane strands extending parallel to the central axis of the housing, each membrane strand comprising an outer shell having an inner diameter defining a lumen, the outer shell having a plurality of pores formed therein; and one or more gas addition/removal apparatuses for facilitating at least one of: a gas addition operation and a gas removal operation. During the gas addition operation, a carrier fluid supplied to the housing interfaces at or near at least one of the plurality of pores with micro-bubbles of a gas supplied to the membrane unit. In addition, an orientation of the at least one fluid inlet and the at least one fluid outlet results in a substantial portion of the carrier fluid traveling parallel to exterior surfaces of the membrane unit thereby allowing for an extended interface time between the carrier fluid and the micro-bubbles of the supplied gas.

Each gas distribution/removal apparatus may be provided at or near the top portion or the bottom portion of the housing and comprises a microporous hollow tubular structure comprising an outer shell having a plurality of pores formed therein and an inner diameter defining a lumen. The hollow tubular structure extends into the housing and through a cavity formed between an end cap of the housing and an upper surface of the membrane unit and further extends into at least a portion of the membrane unit.

The gas addition operation comprises introducing the supplied gas at a specified pressure into the hollow tubular structure. Upon introduction to the hollow tubular structure, the supplied gas undergoes a distribution stage and a diffusion stage. During the distribution stage, the supplied gas diffuses from a lumen side of the hollow tubular structure into the cavity through at least one of the plurality of pores formed in the outer shell of the hollow tubular structure, and moves therefrom into the lumen of at least one membrane strand of the membrane unit. During the diffusion stage, micro-bubbles of the supplied gas diffuse from a lumen side to a shell side of the at least one membrane strand through at least one pore formed in an outer shell thereof and interface with the carrier fluid to generate a chemically altered carrier fluid solution.

The gas removal operation may comprise generating a pressure differential between the lumen side and the shell side of at least one membrane strand of the membrane unit, thereby lowering a partial pressure of a gas dissolved in the carrier fluid and facilitating mass transfer of the dissolved gas from the carrier fluid to generate a chemically altered carrier fluid solution. The gas removal operation may additionally or alternatively comprise supplying an inert gas to the lumen of the at least one membrane strand of the membrane unit, thereby generating a concentration gradient of the dissolved gas between the lumen side and the shell side of the at least one membrane strand and facilitating mass transfer of the dissolved gas from the carrier fluid to generate the chemically altered carrier fluid solution.

A system for chemical alteration of a fluid stream comprises one or more fluid gasification/degasification apparatuses according to one or more embodiments of the invention; a gas transport and dosing system for transporting at least one of: the supplied gas and the inert gas from one or more storage receptacles to the one or more gas addition/removal apparatuses of each of the one or more fluid gasification/degasification apparatuses; and a control system for controlling a mass flow rate of at least one of: the supplied gas and the inert gas into the one or more gas addition/removal apparatuses of each of the one or more fluid gasification/degasification apparatuses in dependence on one or more process parameters, wherein the chemically altered carrier fluid solution generated by the one or more fluid gasification/degasification apparatuses is combined with the fluid stream to generate a chemically altered fluid stream.

The control system comprises a user interface for inputting the one or more process parameters; a system controller that analyzes the inputted parameters to determine an initial mass flow rate for at least one of: the supplied gas and the inert gas, one or more mass flow metering instruments for measuring a mass flow rate of at least one of: the supplied gas and the inert gas; and a chemical analyzer for measuring a parameter indicative of a chemical alteration of the chemically altered fluid stream. Additional chemical analyzers may be provided for measuring parameters indicative of chemical alterations of other fluid streams.

The system controller communicates the determined initial mass flow rate to at least one mass flow valve provided as part of the gas transport and dosing system, which controls introduction of at least one of: the supplied gas and the inert gas into the one or more gas distribution/removal apparatuses of each of the one or more fluid gasification/degasification apparatuses based on the communicated initial mass flow rate, and the system controller adjusts the initial mass flow rate based on at least one of: the measured parameter communicated by the chemical analyzer and the measured mass flow rate in order to achieve a desired chemical alteration of the chemically altered fluid stream.

In accordance with one or more embodiments of the invention, a process for chemically altering a first fluid stream comprises: providing at least one fluid gasification/degasification apparatus according to one or more embodiments of the invention, diverting at least a portion of the first fluid stream as a first side stream; introducing the first side stream to the at least one fluid gasification/degasification apparatus, wherein a fluid pressure of the first side stream is increased to compensate for a pressure drop that occurs as the first side stream passes through the at least one fluid gasification/degasification apparatus; facilitating at least one of: the gas addition operation and the gas removal operation to generate a chemically altered first side stream; and introducing the chemically altered first side stream into the first fluid stream to generate a chemically altered first fluid stream. The chemically altered first side stream generally has a fluid pressure substantially equal to a fluid pressure of the first fluid stream.

These and other embodiments of the invention are described in greater detail through reference to the following drawings.

### BRIEF DESCRIPTION OF THE DRAWINGS

FIG. 1A shows a schematic representation of a system for chemical alteration of a fluid stream in accordance with one or more embodiments of the invention.

FIG. 1B shows a schematic representation of a system for chemical alteration of a fluid stream in accordance with one or more additional embodiments of the invention.

FIG. 2A shows a fluid gasification/degasification apparatus in accordance with one or more embodiments of the invention.

FIG. 2B shows a cross-sectional view of a hollow fiber membrane strand in accordance with one or more embodiments of the invention.

FIG. 2C shows a side view of a hollow fiber membrane strand in accordance with one or more embodiments of the invention.

FIG. 2D shows a detailed cross-sectional view of a gas addition/removal apparatus in accordance with one or more embodiments of the invention.

FIG. 2E shows a schematic view of a system for dual gas addition/removal in accordance with one or more embodiments of the invention.

FIG. 3 shows a flowchart illustrating a process for chemically altering a fluid stream in accordance with one or more embodiments of the invention.

FIG. 4 shows a schematic representation of a system for chemical alteration of a fluid stream in accordance with one or more embodiments of the invention along with associated pHs, pressures and flow rates of various fluid streams.

FIGS. 5A and 5B show experimental data in graphical form that demonstrates the greater efficacy of apparatuses according to embodiments of the invention as compared to conventional apparatuses.

FIG. 6 shows a schematic view of a fluid gasification/degasification apparatus in accordance with one or more additional embodiments of the invention.

### DETAILED DESCRIPTION

Embodiments of the invention relate to apparatuses, systems and processes for gasifying and/or degasifying a fluid. In accordance with one or more embodiments of the invention, a fluid gasification/degasification process is disclosed, which may be employed for chemical alteration of a fluid stream such as, for example, to alter the pH of a fluid stream.

The process utilizes a fluid gasification/degasification apparatus that comprises housing having a vertically aligned central axis that extends between a top portion and a bottom portion of the housing and at least one fluid inlet and at least one fluid outlet positioned at different axial locations along the housing, a membrane unit disposed within the housing and comprising a plurality of bundled microporous hollow fiber membrane strands extending parallel to the central axis of the housing, each membrane strand comprising an outer shell having an inner diameter defining a lumen, the outer shell having a plurality of pores formed therein; and one or more gas addition/removal apparatuses for facilitating at least one of: a gas addition operation and a gas removal operation.

During the gas addition operation, a carrier fluid supplied to the housing interfaces at or near at least one of the plurality of pores with micro-bubbles of a gas supplied to the membrane unit as the micro-bubbles diffuse through the membrane unit. Mixing (and potential reaction) of the supplied gas and the carrier fluid generates a chemically altered carrier fluid solution. The chemically altered carrier fluid solution may then be combined with a fluid stream to yield a chemically altered fluid stream. In more specific embodiments of the invention, the chemically altered carrier fluid solution may have an adjusted pH, resulting in an adjustment of the pH of the fluid stream upon introduction of the chemically altered carrier fluid solution to the fluid stream. However, in other embodiments of the invention, the chemical alteration may relate to a chemical characteristic or property of the fluid(s) other than pH such as, for example, a dissolved concentration of oxygen in the fluid. Further, in various embodiments, an orientation of the at least one fluid inlet and the at least one fluid outlet results in a substantial portion of the carrier fluid traveling parallel to exterior surfaces of the membrane unit thereby allowing for an extended interface time between the carrier fluid and the micro-bubbles of the supplied gas.

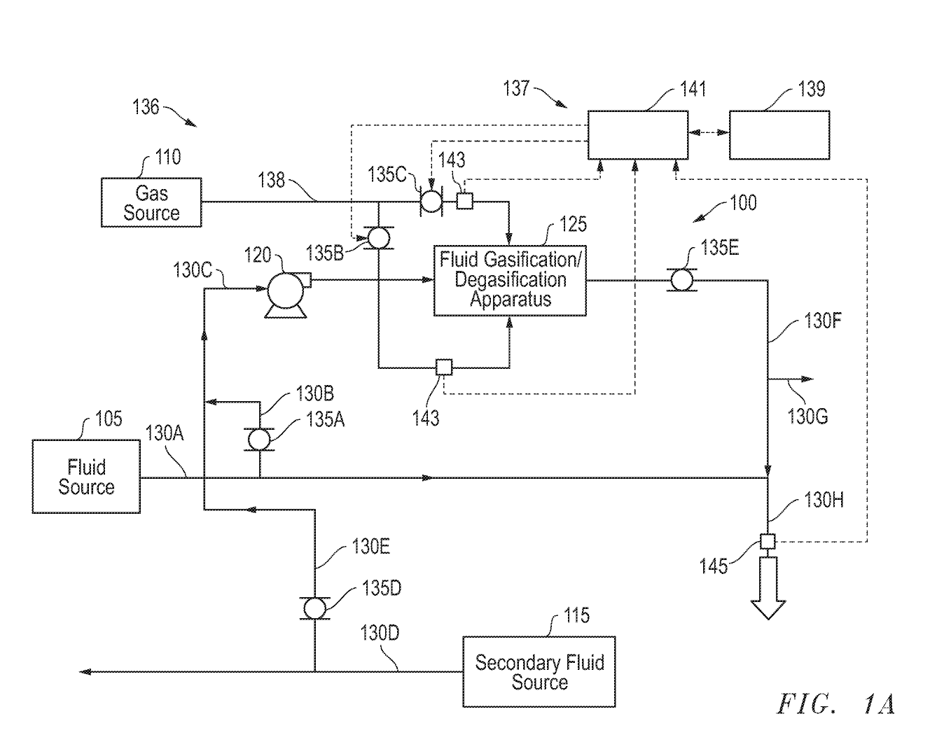

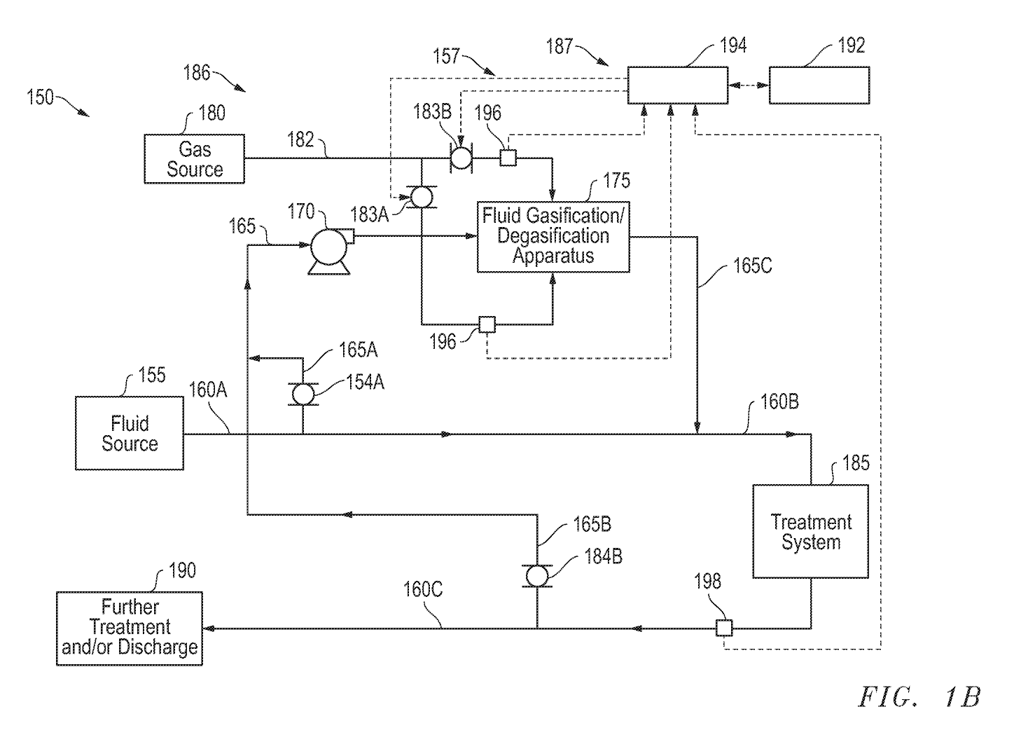

FIG. 1A depicts a schematic representation of a system for chemical alteration of a fluid stream. While FIG. 1A will be described with respect to specific embodiments of the invention involving pH adjustment of a fluid stream; the invention is not so limited, and the system may be employed to alter chemical characteristics or properties of a fluid stream other than pH.

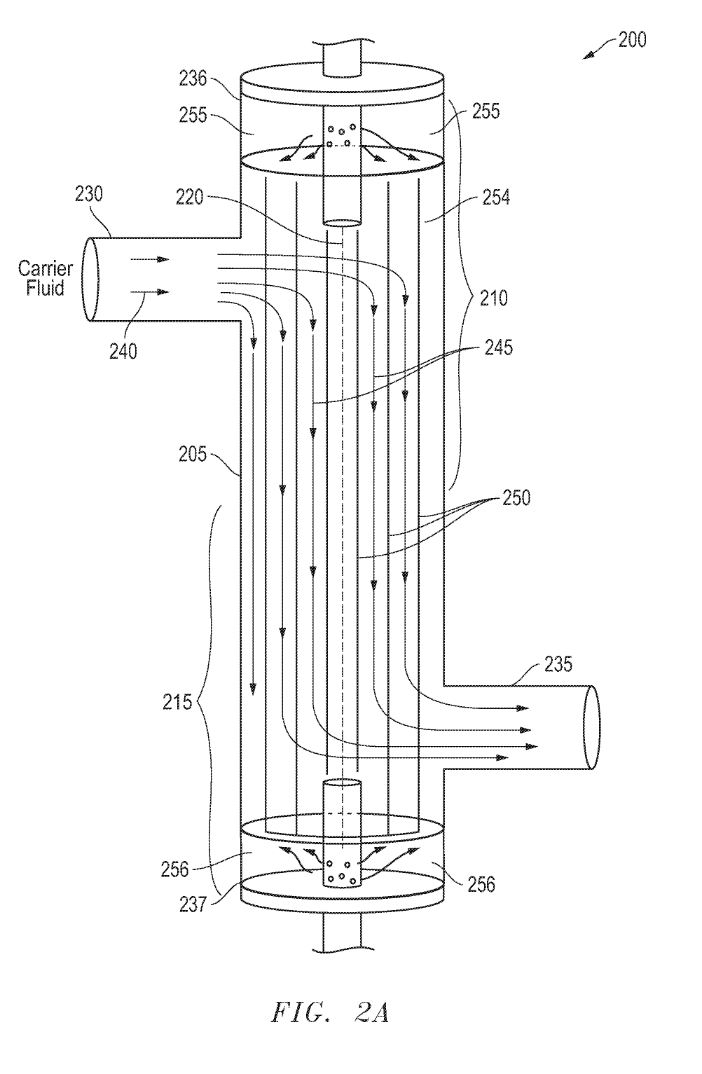

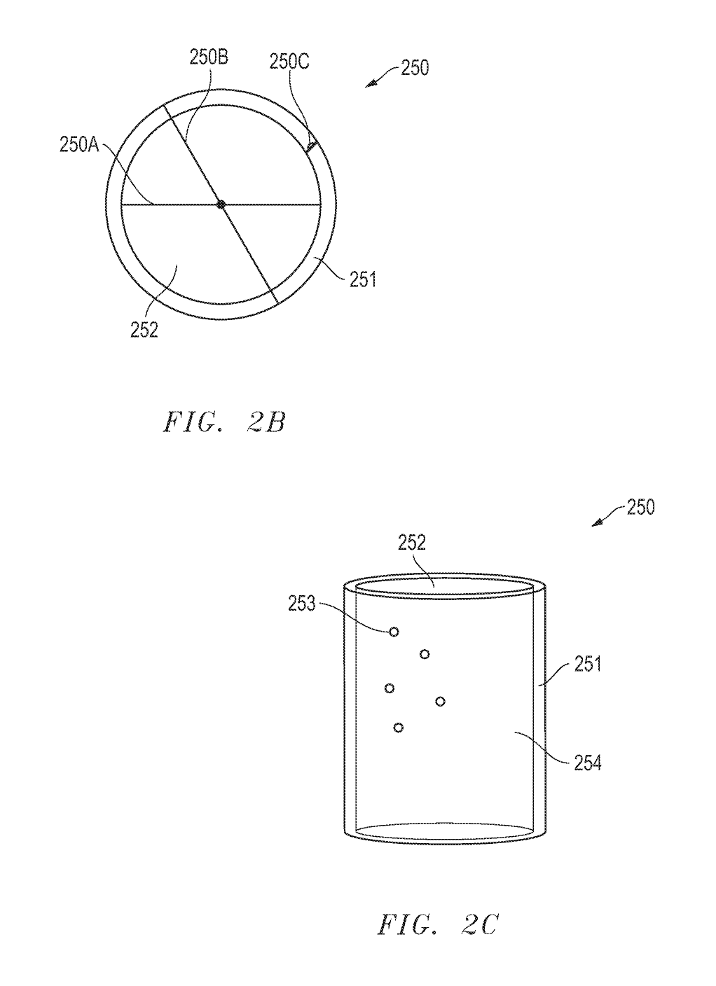

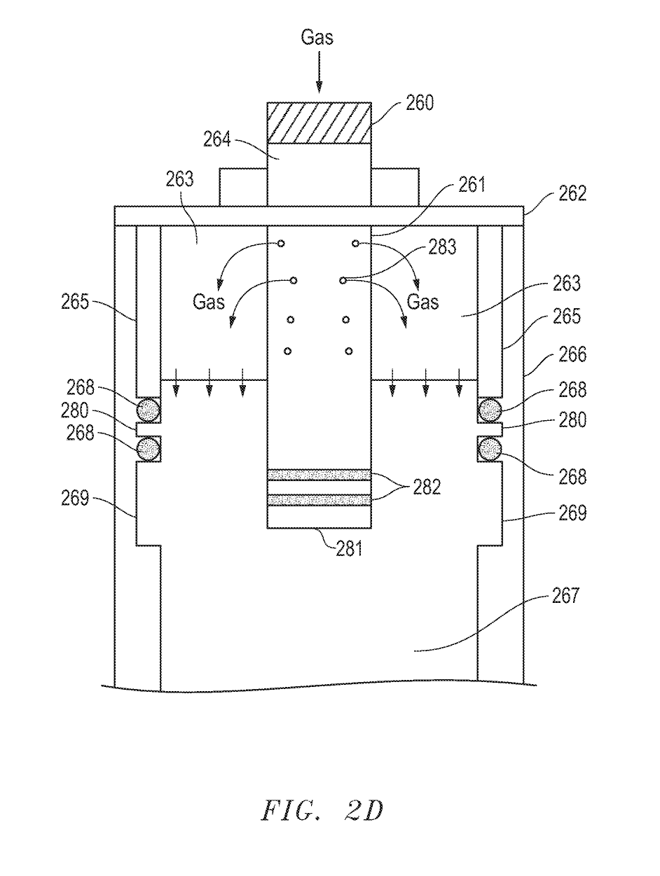

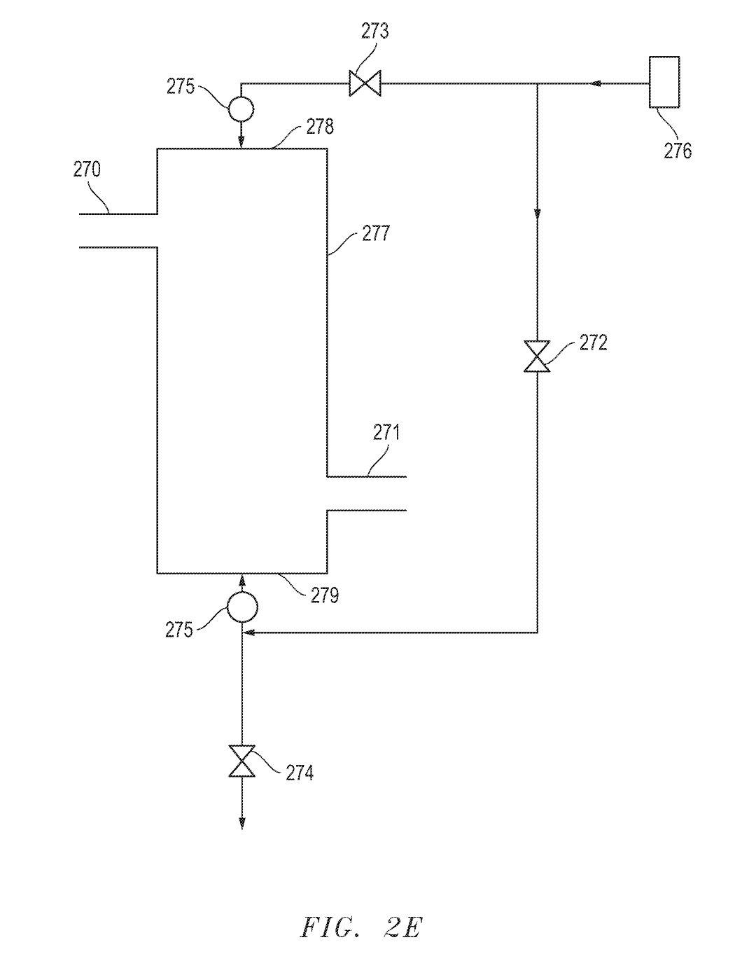

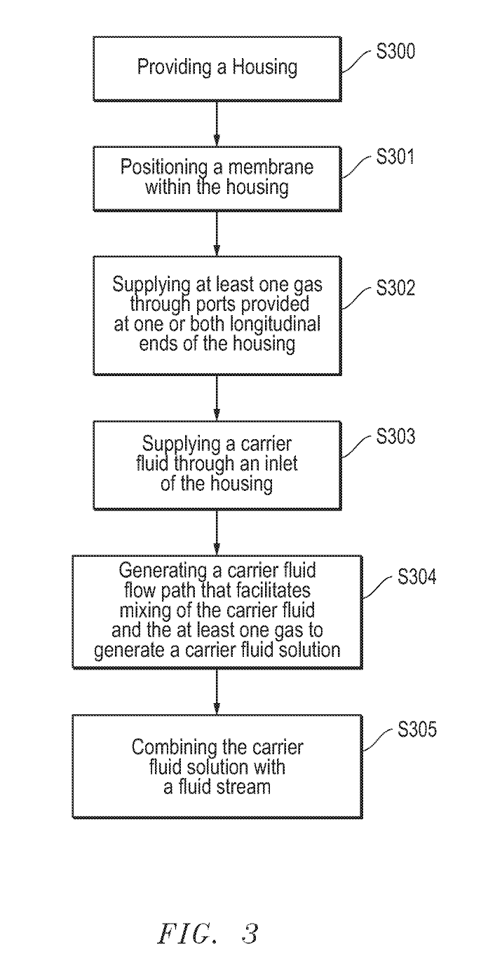

The system 100 includes a fluid source 105 from which fluid stream 130A is generated. A side stream 130B may be diverted from fluid stream 130A to form at least a portion of carrier fluid 130C. A flow rate of side stream 130B may be controlled via valve 135A. Carrier fluid 130C may be injected by pump 120 into fluid gasification/degasification apparatus 125 which increases and/or reduces the concentration of dissolved gas in the carrier fluid 130C. A fluid pressure of carrier fluid 130C may be increased prior to introduction to apparatus 125 so as to compensate for a pressure drop that occurs as the carrier fluid 130C passes through the apparatus 125. This ensures that a fluid pressure of the chemically altered carrier fluid solution 130F is substantially equal to a fluid pressure of fluid stream 130A, thereby facilitating introduction of the carrier fluid solution 130F into the fluid stream 130A. In accordance with one or more embodiments of the invention, the fluid gasification/degasification apparatus 125 may be used to adjust a pH of carrier fluid 130C through the addition and/or removal of one or more gases to/from carrier fluid 130C. The fluid gasification/degasification apparatus 125 will be described in more detail hereinafter through reference to FIGS. 2A-2E. While embodiments of the invention will be described primarily with respect to fluid gasification apparatuses and processes, it should be understood that those same apparatuses and processes are also capable of degasifying a fluid with only slight modifications to the apparatus and/or the process.

System 100 further comprises a gas transport and dosing system 136 and a control system 137. The gas transport and dosing system 136 may comprise a gas source 110, piping 138 for transporting gas from the gas source 110 to apparatus 125, and valves 135B, 135C. The gas transport and dosing system 136 may further comprise a manual gas feed control valve (not shown) for dosing gas manually. Manual dosing of gas to the fluid gasification/degasification apparatus at a specified gas flow rate may also be achieved through a user interface provided as part of the control system (described below). Gas source 110 may comprise any receptacle suitable for containing and storing gaseous compounds such as, for example, one or more storage tanks. The size and design of the receptacles may be tailored to a particular application. For example, the storage tanks may range from small 450 lb. dewars to larger bulk gas storage systems that recapture essentially all gas lost during storage. If gas source 110 becomes depleted, the system 100 may comprise an alarm mechanism to notify an operator, and secondary gas sources such as secondary storage tanks may be provided to supply gas during replenishment of gas source 110.

During the gas addition operation, carrier fluid 130C mixes (and potentially reacts) with at least one gas supplied to apparatus 125, thereby leading to gasification of the carrier fluid 130C. As will be described in more detail through reference to FIGS. 2D and 2E, as part of the gas addition operation, gas may be introduced to apparatus 125 through gas ports provided in proximity to a top portion and/or a bottom portion of the apparatus 125. Valves 135B, 135C are provided to control a flow rate of gas to the apparatus 125. The gas may be carbon dioxide, oxygen, hydrogen, or a combination thereof; however, it should be noted that embodiments of the invention are not so limited and any suitable gas or mixture(s) of gases may be used. According to one or more embodiments of the invention, a suitable gas or mixture of gases may be any gaseous compound(s) that results in a suitable level of gaseous concentration of the carrier fluid 130C, a suitable degree of chemical alteration of carrier fluid 130C (e.g. pH adjustment) upon mixing of the gas and the carrier fluid 130C, and/or a suitable degree of chemical alteration (e.g. pH adjustment) of a fluid stream into which the chemically altered fluid solution 130F is introduced.

As will be described in more detail through reference to FIG. 2D, as part of the gas addition operation, gas is supplied at a specified pressure into one or more gas addition/removal apparatuses, each being provided at or near a top portion or a bottom portion of the housing of fluid gasification/degasification apparatus 125. More specifically, the gas is introduced into a hollow tubular structure of the gas additional/removal apparatus and proceeds to undergo a distribution stage and a diffusion stage. During the distribution stage, the supplied gas diffuses from a lumen side of the hollow tubular structure through at least one of a plurality of pores formed in an outer shell thereof into a cavity formed between an end cap of the housing and an upper surface of the membrane unit. The gas is then distributed or distributes itself from the cavity into the lumina of the membrane strands of which the membrane unit is comprised. During the diffusion stage, micro-bubbles of the supplied gas diffuse from a lumen side to a shell side of the membrane strands through the pores formed in the outer shells thereof and interface with the carrier fluid to generate the chemically altered carrier fluid solution 130F.

Mixing of the micro-bubbles of the supplied gas and carrier fluid 130C produces a solution 130F of the carrier fluid having the gas dissolved therein which may then be combined with fluid stream 130A. A side stream 130G may be diverted from the carrier fluid solution 130F and subjected to various treatment processes. In accordance with one or more embodiments of the invention, carrier fluid solution 130F may have an adjusted pH as compared to the pH of the carrier fluid 130C prior to introduction to apparatus 125, and as such, addition of the carrier fluid solution 130F to fluid stream 130A may result in an adjustment of the pH of fluid stream 130A. Fluid stream 130H having an adjusted pH may then be introduced to another fluid stream, resulting in an adjustment of the pH of that fluid stream. In addition, side stream 130G, which may be diverted from carrier fluid solution 130F, may be introduced into an alternate fluid stream (not shown). Further, the combination of any number of fluid streams in order to achieve a desired effect (e.g. pH adjustment) is within the scope of this disclosure. Any of the fluid streams having an adjusted pH may have a pH in the range of about 2.0 to about 14.0.

Gasification/degasification apparatus 125 may also be used to perform a gas removal operation in which mass transfer of a gas dissolved in the carrier fluid 130C is facilitated, thereby resulting in a reduced concentration of the dissolved gas. The gas removal operation may comprise generating a pressure differential between the lumen side and the shell side of at least one membrane strand of the membrane unit, thereby lowering a partial pressure of the gas dissolved in the carrier fluid 130C and facilitating mass transfer of the dissolved gas from the carrier fluid 130C to generate the chemically altered carrier fluid solution 130F. For example, the pressure within the lumina of the membrane strands may be reduced (potentially to a near vacuum) leading to the formation of a dissolved gas concentration gradient across the outer shells of the membrane strands which in turn forces the dissolved gas out of solution. The gas then diffuses through the pores formed in the outer shells of the membrane strands and is removed via the one or more gas addition/removal apparatuses.

In conjunction with the generation of a pressure differential, or as an alternative thereto, an inert gas may be supplied to the membrane unit at a specified pressure via the one or more gas addition/removal apparatuses to in order to facilitate removal of gas from the carrier fluid. The inert gas may be supplied from gas source 110 or from an alternate gas source (not shown). More specifically, the inert gas may be supplied to the lumen of at least one membrane strand of the membrane unit, thereby generating a concentration gradient of the dissolved gas between the lumen side and the shell side of the at least one membrane strand and facilitating mass transfer of the dissolved gas from the carrier fluid to generate the chemically altered carrier fluid solution 130F. Similar to the gas addition operation, mass transfer (i.e. removal) of dissolved gas from the carrier fluid 130C may generate a carrier fluid solution 130F having an adjusted pH which may then be combined with another fluid stream (e.g. fluid stream 130A) to generate a pH adjusted fluid stream (e.g. 130H).

In accordance with one or more embodiments of the invention, a secondary fluid stream 130D may be generated from a secondary fluid source 115. A secondary side stream 130E may be diverted from the secondary fluid stream 130D to form at least part of the carrier fluid 130C. A flow rate of the secondary fluid stream 130D may be controlled by valve 135D. Use of a secondary side stream 130E to form at least part of the carrier fluid 130C may be particularly advantageous in treatment applications having high TSS or contaminants. In various embodiments, the secondary fluid stream 130D may correspond to the effluent stream from one or more treatment systems. In alternate embodiments, the secondary side stream 130E may be diverted from a fluid stream 130D better suited for flow through the membrane unit. In certain embodiments, secondary side stream 130E may be combined in any proportion with side stream 130B to form carrier fluid 130C, while in other embodiments, secondary side stream 130E alone or side stream 130B alone may form the carrier fluid 130C.

Valves for controlling the flow rates of various fluid streams may be provided at various positions in the system depicted in FIG. 1A. For example, valves 135A and 135D are positioned so as to control the flow rate of side stream 130B and the flow rate of secondary side stream 130E, respectively. Valve 135E is provided to control the flow rate of the chemically altered carrier fluid solution 130F that exits apparatus 125.

The control system 137 comprises a user interface 139, a system controller 141, one or more mass flow metering instruments 143 for measuring a mass flow rate of the gas supplied to apparatus 125 during the gas addition operation and/or a mass flow rate of the inert gas supplied to apparatus 125 during the gas removal operation, and a chemical analyzer 145 for measuring a parameter indicative of a chemical alteration of a fluid stream. In one or more specific embodiments of the invention, the chemical analyzer 145 may be a pH probe that measures a pH of a fluid stream.

The user interface 139 may be a human-machine interface (HMI) of any suitable type (e.g. a touch-screen interface) and the system controller 141 may be, for example, a programmable logic controller. User interface 139 provides an operator with the capability to input one or more process parameters based on the specific requirements of the particular application for which the system is being used. The one or more process parameters may include a desired chemical alteration of carrier fluid 130C and/or fluid stream 130A (e.g. a desired pH for the carrier fluid solution 130F and/or a desired pH for fluid stream 130H). The one or more process parameters may further include a specified interface time between the carrier fluid 130C and the diffused gas, a fluid flow resulting from a booster pump feeding the membrane unit, and/or a discharge pressure after the membrane unit.

System controller 141 analyzes the inputted process parameters to determine an initial mass flow rate for gas introduced to apparatus 125. This initial mass flow rate is communicated to one or both of valves 135B, 135C, which in turn control the flow rate of gas introduced to the apparatus 125 based on the communicated initial mass flow rate. It should be noted that the initial mass flow rate may—as part of the gas removal operation—correspond to an initial rate at which the inert gas is supplied to the fluid gasification/degasification apparatus.

The mass flow metering instruments 143 are shown in FIG. 1A disposed between valve 135B and apparatus 125 and between valve 135C and apparatus 125. However, the mass flow metering instrument(s) 143 may be disposed at any location in the gas feed line to the membrane unit prior to injection of gas into the membrane unit. That is, the mass flow metering instrument(s) 143 may be disposed anywhere between gas source 110 and apparatus 125. Metering instruments 143 measure the mass flow rate of gas introduced to apparatus 125 and communicate the measured mass flow rate as an input parameter to system controller 141. In certain embodiments of the invention, metering instruments 143 may also measure a mass flow rate of gas removed from the carrier fluid via apparatus 125.

The following discussion relates to those embodiments in which the chemical analyzer 145 is a pH probe; however, as previously noted, the chemical analyzer may be any device that measures a parameter indicative of a chemical alteration of a fluid stream (e.g. a device that measures a concentration of dissolved gas). The pH probe 145 may be disposed so as to measure the pH of fluid stream 130H (i.e., the stream that results from the introduction of the carrier fluid solution 130F to fluid stream 130A). In various embodiments of the invention, addition chemical analyzers 145 may be provided. For example, additional pH probes 145 may be provided to measure the pHs of additional fluid streams such as, for example, side stream 130B, secondary side stream 130E, pH adjusted carrier fluid solution 130F prior to introduction into fluid stream 130A, etc. The measured pHs may then be communicated as input parameters to system controller 141. Based on one or both of the measured pH and the measured mass flow rate of gas, system controller 141 may modulate the mass flow rate of gas to apparatus 125 by controlling one or both of valves 135B, 135C as necessary to achieve a desired result (e.g. a desired pH for a fluid stream). In scenarios that require dynamic gas dosing, an operator may employ user interface 139 to manually adjust the mass flow rate of gas injected into apparatus 125. In various alternate embodiments, gas dosing may be manually controlled via manual gas valve independently of the mass flow metering instruments 143 and the user interface 139.

Mass flow metering instruments 143 and chemical analyzer 145 are two types of sensing/measurement devices that may supply feedback data to system controller 141. However, any suitable sensor/measurement device may be provided at any number of positions within the system/process flow depicted in FIG. 1 to measure process parameters and provide feedback to system controller 141 in order to obtain a desired chemical alteration (e.g. a desired pH for a fluid stream).

According to one or more embodiments of the invention, certain elements of system 100 described as being part of the gas transport and dosing system 136 (e.g. valves 135B, 135C) may instead be considered as part of the control system 137. Similarly, certain elements described as being part of the control system 137 (e.g. mass flow metering instruments 143) may be considered as part of the gas transport and dosing system 136. Moreover, in certain embodiments of the invention, various elements may be thought of as part of both the control system 137 and the gas transport and dosing system 136 simultaneously. That is, in certain embodiments of the invention, sub-systems may be distinct from each other and share no common structural elements, while in other embodiments, sub-systems may have shared structural elements.

FIG. 1B schematically depicts a system 150 for carrying out a process for chemically altering a fluid stream using a gasification/degasification apparatus in accordance with one or more additional embodiments of the invention. While FIG. 1B will be described through reference to specific embodiments involving pH adjustment of a fluid stream, the process may be applied to alter a chemical characteristic or property of a fluid other than pH.

System 150 is similar to system 100 depicted in FIG. 1 in many respects, and one or ordinary skill in the art will understand that any components of system 150 not specifically addressed or elaborated upon with respect to system 150 correspond substantially in structure and function to similar components discussed in relation to system 100.

Among the ways in which system 150 differs from system 100 is in the subsequent treatment and use of pH adjusted fluid stream 160B, which corresponds to fluid stream 160A after pH adjusted carrier fluid solution 165C is introduced thereto. Fluid stream 160B is subjected to one or more treatment processes in treatment system 185, and subsequently, a side stream 165B of the treated fluid stream 160C may be used to form at least part of the carrier fluid 165 introduced to gasification/degasification apparatus 175.

Treatment system 185 may in practice be a combination of one or more treatment subsystems that subject fluid stream 160B to one or more treatment processes for the removal of, for example, organic or inorganic contaminants from the fluid stream. Alternatively, the one or more treatment processes may be any number of physical, biological, or chemical treatment processes which a fluid stream may be subjected to at any stage in its overall treatment.

System 150 comprises a gas transport and dosing system 186 and a control system 187 that correspond substantially in structure and function to the gas transport and dosing system 136 and control system 137 of the system 100 depicted in FIG. 1. Similar to the gas transport and dosing system 136 of system 100, the gas transport and dosing system 186 comprises a gas source 180, piping 182 for transporting gas from the gas source 180 to apparatus 175, and valves 183A, 183B. The gas transport and dosing system 186 may further comprise a manual gas control valve (not shown) for dynamically/manually controlling gas injection Like gas source 110, gas source 180 may comprise any receptacle suitable for containing and storing gaseous compounds.

The control system 187 comprises a user interface 192, a system controller 194, one or more mass flow metering instruments 196 for measuring a mass flow rate of gas to/from apparatus 175, and a chemical analyzer (e.g. a pH probe) 198 for measuring a parameter indicative of a chemical alteration (e.g. a pH) of a fluid stream. As with system 100, user interface 192 provides an operator with the capability to input one or more process parameters which system controller 194 analyzes to determine an initial mass flow rate for gas introduced to apparatus 175. This initial mass flow rate is communicated to one or both of valves 183A, 183B which control the flow rate of gas to apparatus 175 based on the communicated initial mass flow rate. In one or more specific embodiments of the invention, the one or more process parameters may include a desired pH for the carrier fluid solution 165C and/or a desired pH for fluid stream 160B. The desired pH for the carrier fluid solution 165C and/or fluid stream 160B may be in the range of about 2.0 to about 14.0.

Mass flow metering instrument(s) 196 are shown in FIG. 1B disposed between valve 183B and apparatus 175 and between valve 183A and apparatus 175. However, the mass flow metering instrument(s) 196 may be disposed at any location in the gas feed line to the membrane unit prior to injection of gas into the membrane unit. That is, the mass flow metering instrument(s) 196 may be disposed anywhere between gas source 180 and apparatus 175. The metering instrument 196 measures the mass flow rate of gas introduced to apparatus 175 and communicates the measured mass flow rate as an input parameter to system controller 194.

The chemical analyzer (e.g. pH probe) 198 may be disposed, for example, in fluid stream 160B. As in the embodiment depicted in FIG. 1, additional chemical analyzers may be provided. For example, additional pH probes 198 may be provided to measure the pHs of additional fluid streams such as, for example, fluid stream 160A, side stream 165A, secondary side stream 165B, etc. The pH probe 198 measures the pH of fluid stream 160B and communicates the measured pH as an input parameter to system controller 194. In response to the measured pH and/or mass flow rate measurements, system controller 194 may modulate the mass flow rate of gas by controlling one or both of valves 183A, 183B to increase or decrease the flow rate of gas to apparatus 175 as necessary to achieve a desired chemical alteration (e.g. a desired pH for fluid stream 160B). In scenarios that require dynamic gas dosing, an operator may employ user interface 192 to manually adjust the mass flow rate of gas injected into apparatus 175. In various alternate embodiments, gas dosing may be manually controlled via a manual gas valve independently of the mass flow metering instruments 196 and the user interface 192.

In one or more embodiments of the invention, the pH probe 198 may be disposed downstream from where the pH adjusted carrier fluid solution 165C is introduced into fluid stream 160A to form fluid stream 160B. In more specific embodiments of the invention, pH probe 198 may be disposed downstream from treatment system 185. By virtue of its placement downstream from treatment system 185, pH probe 198 encounters a cleaner fluid stream (i.e. treated fluid stream 160C) rather than fluid stream 160B immediately upstream from treatment system 185, thereby ensuring greater long-term viability of the probe and less maintenance.

After fluid stream 160B is subjected to treatment in treatment system 185 to yield a secondary fluid stream 160C, a secondary side stream 165B may be diverted from the secondary fluid stream 160C to form at least part of the carrier fluid 165. Secondary fluid stream 160C may undergo further treatment and/or discharge. Secondary side stream 165B may be introduced into apparatus 175 as at least a portion of carrier fluid 165. Side stream 165A which is diverted from fluid stream 160A and/or secondary side stream 165B which is diverted from fluid stream 160C may be combined in any proportion to form carrier fluid 165. Further, either of the side streams may represent about 1% to about 75% of the total flow of the liquid stream from which the side stream was diverted (i.e. fluid stream 160A and secondary fluid stream 160C, respectively).

Referring to FIG. 2A, a fluid gasification/degasification apparatus 200 in accordance with one or more embodiments of the invention includes housing 205 that includes a top portion 210, a bottom portion 215, and a vertically aligned central axis 220 that extends between the top portion 210 and the bottom portion 215. The housing 205 further includes a fluid inlet 230 and a fluid outlet 235 that are positioned at different axial locations along the housing 205. Although the inlet 230 and the outlet 235 are shown in FIG. 2A extending radially outwards from the housing 205 along axes that are 180 degrees apart, embodiments of the invention are not so limited and other inlet and outlet orientations are possible, including orientations in which the inlet and the outlet extend from the housing along respective axes that meet at an angle θ where 0°≦θ≦180° (or 360° depending on how the angle is measured). According to one or more particular embodiments of the invention, the inlet and outlet may be oriented so as to extend from the housing along respective axes that meet at an angle θ where 45≦θ≦135°.

In accordance with one or more embodiments of the invention, a carrier fluid 240 is pumped into the housing 205 through inlet 230 at or above system pressure. A fluid pressure of carrier fluid 240 may be increased prior to introduction to the housing 205 in order to compensate for a pressure drop that occurs as the carrier fluid 240 passes through the apparatus 200.

The apparatus 200 may further include a membrane unit 254 disposed within the housing 205. In certain embodiments of the invention, a plurality of membrane units may be employed in parallel or series configurations. The membrane unit 254 comprises a plurality of microporous hollow fiber membrane strands 250, each membrane strand 250 being disposed within the housing 205 and extending in a direction substantially parallel to the central axis 220 of the housing 205. Each hollow fiber membrane strand 250 may be formed from a polymer including a thermoplastic polymer such as a polypropylene or polyethylene material. The membrane unit 254 may comprise hundreds of tightly bundled hollow fiber membrane strands 250. As a result of an orientation of the inlet 230 and the outlet 235, at least a substantial portion of the carrier fluid 240 travels parallel to exterior surfaces of the membrane unit thereby allowing for an extended interface time between the first side stream and the micro-bubbles of the supplied gas.

Referring to FIG. 2B, each hollow fiber membrane strand 250 may have a substantially cylindrical shape and comprise an inner diameter 250A and an outer diameter 250B. A width 250C of an outer shell 251 of a membrane strand 250 is defined by the difference between the outer diameter 250B and the inner diameter 250A. Further, the inner diameter 250A of a membrane strand 250 defines a lumen 252 of the strand 250. Referring to FIG. 2C, each membrane strand 250 includes micropores 253 formed in the outer shell 251. The pores 253 are schematically shown in FIG. 2C, and it should be understood that the pores 253 may be formed in the outer shell 251 in any number and/or arrangement. As a result of the small pore diameter, the microporous membrane strands 250 are permeable to molecules of at least one gas and substantially resistant to permeation of the carrier fluid molecules. The membrane strands 250 are permeable to, for example, carbon dioxide molecules which have a molecular diameter of approximately 0.00387 microns (3.87×10⁻⁷ mm). The pores in the membrane strands 250 may be sized so as to be permeable to one or more gases and resistant to permeation of one or more carrier fluid compounds. A membrane that is formed of hollow membrane strands that are impermeable to water molecules may be referred to as a hydrophobic membrane. The membrane unit 254 may further comprise a filter (not shown) that protects the membrane from particulate damage, maintains efficiency, and improves the life expectancy of the membrane 254.

Referring now to FIGS. 2A-2C, as part of the gas addition operation, a gas or mixture of gases (e.g. carbon dioxide) is injected into a gas addition/removal apparatus provided at or near the top portion 210 and/or the bottom portion 215 of the housing 205. As will be described in more detail through reference to FIG. 2D, the gas addition/removal apparatus comprises a hollow tubular structure that extends into the housing 205 and partially extends into the membrane unit 254. Gas introduced to the hollow tubular structure diffuses—as part of a distribution stage of the gas addition operation—through pores formed therein and into one or more cavities 255 and 256 provided between the membrane unit 254 and end caps 236 and 237, respectively, of the housing 205. The gas is then distributed or distributes itself across the membrane unit 254, and in particular, into the lumina 252 of the membrane strands 250. During the gas removal operation, the inert gas may be supplied to the gas addition/removal apparatus in a similar manner.

After the gas is introduced into the housing 205 and distributed through the lumina 252 of the plurality of membrane strands 250, the gas undergoes a diffusion stage in which the gas travels through the lumina 252 and diffuses through the pores 252 formed in the outer shells 251 of the membrane strands 250. More specifically, micro-bubbles of the gas diffuse through the pores 253 and interface with the carrier fluid 240 at or near the pores 253. The micro-bubbles that diffuse through the pores 253 possess a high surface area to volume ratio that increases the relative surface area available for contacting the carrier fluid 240 is it travels from the inlet 230 of the housing 205 to the outlet 235. As carrier fluid molecules and gas molecules interface, mixing and potential reaction occurs. In those embodiments of the invention in which the gas is carbon dioxide and the carrier fluid is water or is comprised primarily of water, water molecules and carbon dioxide molecules react almost instantaneously upon contact to form carbonic acid.

As previously mentioned, carrier fluid 240 may be pumped through the inlet 230 of the housing 205 at a slightly elevated fluid pressure in order to compensate for a pressure drop that occurs as the carrier fluid 240 passes through the fluid gasification/degasification apparatus. However, it is neither necessary nor desirable for the carrier fluid 240 to be pumped into the housing 205 at a highly elevated pressure that would yield a super-saturated carrier fluid solution. The pressure of the carrier fluid may, for example, be increased prior to introduction to the fluid gasification/degasification apparatus in order to compensate for a 5-20 psi pressure drop through the apparatus. This ensures that the chemically altered carrier fluid solution has a fluid pressure substantially equal to the fluid stream to which it is introduced.

As previously noted, an orientation of the fluid inlet 230 and the fluid outlet 235 results in a substantial portion of the carrier fluid 240 traveling parallel to exterior surfaces of the membrane unit 254 thereby allowing for an extended interface time between the carrier fluid 240 and the micro-bubbles of the supplied gas. This parallel flow path 245 of the carrier fluid provides advantages over conventional apparatuses such as longer interface time between the carrier fluid and the supplied gas and additional mixing through fluid dynamics. After the carrier fluid 240 is introduced into the housing 205, some portion of the carrier fluid 240 may initially travel across a width of the housing 205 (the width of the housing 205 being measured in a direction substantially perpendicular to the central axis 220 of the housing 205). In traveling across the width of the housing 205, the carrier fluid molecules may travel around the exterior surfaces of the outer shells 251 of the hollow fiber membrane strands 250, but generally do not permeate through the pores of the membrane strands due to the substantially resistant nature of the microporous membrane to permeation by carrier fluid molecules.

According to one or more embodiments of the invention, the membrane unit 254 may comprise hundreds of relatively tightly packed membrane strands. As such, the carrier fluid 240 generally will not travel through the membrane unit 254 (i.e. around exterior surfaces of the membrane walls 251 of hollow fiber membrane strands 250 located towards an interior of the membrane unit 254). That is, the carrier fluid 240 will generally travel along a parallel flow path that results in contact between carrier fluid molecules and gas molecules at or near pores of membrane strands 250 located towards or along an outer periphery of the membrane 254.

Due to the substantially parallel flow path 245 shown in FIG. 2A, both the area of contact and the duration of contact between carrier fluid molecules and supplied gas molecules is significantly increased relative to conventional apparatuses and methods. In conventional apparatuses, the carrier fluid traverses a tangential flow path across membrane fiber strands. Tangential flow of the carrier fluid reduces both the carrier fluid flow rate through the housing and the contact time between carrier fluid molecules and gas molecules that diffuse through the membrane strands. As such, fluid gasification/degasification apparatuses according to embodiments of the invention can achieve significantly higher carrier fluid flow rates and interface times than conventional apparatuses.

An apparatus in accordance with one or more embodiments of the invention may produce a carrier fluid flow rate of about 5.7×10⁻² to about 3.45 gpm (gallons per minute) per square foot of membrane surface area. This equates, for example, to 5-300 gallons per minute of flow for a 4 inch by 13 inch membrane unit having 87 square feet of surface area. It should be noted that embodiments of the invention are not limited to a membrane unit having a specific height and width. Membrane units of varying lengths and widths may be employed such as, for example, a 6 inch by 28 inch membrane unit. Further, according to one or more embodiments of the invention, the membrane unit (which includes a plurality of bundled membrane strands) is capable of achieving gas diffusion rates of about 1.15×10⁻² to about 11.49 standard cubic feet per hour (SCFH) per square foot of membrane surface area. This equates, for example, to 1-1000 SCFH of carbon dioxide for a 4 inch by 13 inch membrane unit having 87 square feet of surface area. One of ordinary skill in the art will appreciate that these dimensions and numerical figures are presented purely by way of example and are not intended to be limiting. Any membrane of any dimension, any suitable gas diffusion rate, and any suitable carrier fluid flow rate are encompassed by this disclosure.

FIG. 2D provides a detailed cross-sectional view of a gas addition/removal apparatus in accordance with one or more embodiments of the invention. The gas addition/removal apparatus facilitates the introduction and/or removal of a gas to/from the fluid gasification/degasification apparatus. The gas addition/removal apparatus shown in FIG. 2D may be provided at or near a top portion or a bottom portion of the fluid gasification/degasification apparatus thereby providing for introduction/removal of gas from one or both longitudinal ends of the fluid gasification/degasification apparatus.

While operation of the gas addition/removal apparatus will be described through reference to a gas addition operation that forms part of a gasification process, it should be noted that the apparatus is also capable of facilitating a gas removal operation as part of a degasification process. More specifically, as part of the gas removal operation, the gas addition/removal apparatus may facilitate removal of dissolved gas, and potentially, introduction of an inert gas to the fluid gasification/degasification apparatus.

The gas addition/removal apparatus includes a hollow tubular structure 264 that extends into the housing 266. The hollow tubular structure 264 includes a threaded portion 260 for connection to a gas supply source (not shown). At least one gas may be introduced into the hollow tubular structure 264. A cavity 263 is formed between an end cap 262 of the housing 266 and the microporous membrane 267 by means of cylindrical spacer 265 that spaces the end cap 262 from the membrane 267. As part of a distribution stage of the gas addition operation, the gas introduced into the hollow tubular structure 264 diffuses into the cavity 263 through pores 283 formed in the hollow tubular structure 264. The gas is then actively distributed or distributes itself among the membrane strands of the membrane 267, and more specifically, into lumina of the membrane strands.

Various O-ring seals 268 may also be provided to form a tight seal between the membrane 267 and the housing 266. The seals 268 fully seal off the cavity 263 and ensure that gas molecules entering the hollow fiber membrane strands of the membrane 267 do not escape into other portions of the housing 266. The membrane may include thickened portions 269, 280 provided on either side of the membrane along its width to seat or support the seals 268. The gas addition/removal apparatus further includes a cap 281 provided to seal off an end of the hollow tubular structure 264 and may additionally include seals 282 provided circumferentially around the hollow tubular structure 264.

FIG. 2E depicts a schematic representation of gas addition/removal through ports provided at either longitudinal end of the gasification/degasification apparatus. Gas may be provided via a gas source 276 for introduction into the housing 277 through a port provided at or near a top portion 278 of the housing 277 and a port provided at or near a bottom portion 279 of the housing 277. A gas addition/removal port may correspond to the gas addition/removal apparatus described through reference to FIG. 2D.

Referring to FIG. 2E, valves 272, 273 may be isolation valves that are capable of single and dual port gas addition. Closing of valve 272 and the opening of valve 273 permits gas addition through the port provided at or near the top portion 278 of the housing 277 (i.e. the port closest to the inlet 270) and prevents gas addition through the port provided at or near the bottom portion 279 of the housing 277. Alternately, closing of valve 273 and the opening of valve 272 permits gas addition through the port provided at or near the bottom portion 279 (i.e. the port closest to the outlet 271) and prevents gas addition through the port provided at or near the top portion 278. During gas addition/removal through the port closest to the outlet 271, valve 274 is generally also in a closed position. However, valve 274 may be opened in order to flush out any fluid that is present in the hollow membrane fibers. Valve 274 may also be opened to allow for low volume gas flow through the full length of the membrane fibers, thereby increasing the efficiency of gas diffusion through the pores provided in the membrane walls of the membrane fibers. One or more mass gas flow metering devices 275 may be provided to measure a gas flow rate through one of more of the ports.

As noted earlier, apparatuses in accordance with various embodiments of the invention provide various advantages over conventional apparatuses. In particular, apparatuses, systems, and processes according to embodiments of the invention provide for increased area of contact and increased contact/interface time between the carrier fluid and the gas that diffuses or permeates through the pores of the membrane unit. The contact/interface time between the carrier fluid and diffused gas may be specified based on a desired chemical alteration of a fluid stream. For example, the interface time may be specified in order to achieve a desired adjusted pH for a fluid stream. The increased contact area and contact time result from one or more of the following: (1) increased carrier fluid flow rate, (2) an orientation of the fluid inlet and fluid outlet that directs the carrier fluid along a flow path that facilitates interfacing between the carrier fluid and the supplied gas and/or dissolved gas, and (3) the smaller volume (and consequently higher surface area to volume ratio) of gaseous micro-bubbles that diffuse through the pores formed in the outer shells of the membrane strands of the membrane unit. Although embodiments of the invention have been described primarily with respect to parallel carrier fluid flow paths, alternate non-rotational or non-circular flow paths are also within the scope of the invention. For example, the inlet and outlet of the housing of the fluid gasification/degasification apparatus may be oriented such that the carrier fluid is directed along a non-parallel, non-rotational flow path that provides the same advantages over conventional systems as the parallel flow path.

As noted earlier, conventional apparatuses generate substantially tangential carrier fluid flow across the membrane, which results in decreased flow rates, decreased contact area, and decreased contact time between carrier fluid molecules and gas molecules that diffuse through the membrane unit. Some conventional apparatuses employ larger membranes but continue to generate a tangential carrier fluid flow path. Further, certain conventional apparatuses employ a gas sparger that disperses gas in large bubbles into the carrier fluid. These apparatuses, however, suffer from the same drawbacks of reduced contact area and reduced contact time between gas molecules and carrier fluid molecules. In sharp contrast, apparatuses in accordance with various embodiments of the invention provide for increased contact time and increased surface contact area between carrier fluid molecules and gas molecules. The increased contact area and contact time increases the amount of interfacing/mixing between the gas and the carrier fluid, and consequently, the degree of gasification or degasification of the carrier fluid. Moreover, because apparatuses according to embodiments of the invention generate a parallel carrier fluid flow path rather than the tangential carrier fluid flow path observed in conventional apparatuses, significantly less stress on the membrane is observed during operation of apparatuses of the invention as compared to conventional apparatuses. In addition, less risk of damage to the membrane from the impact of foreign objects exists with apparatuses of the invention.

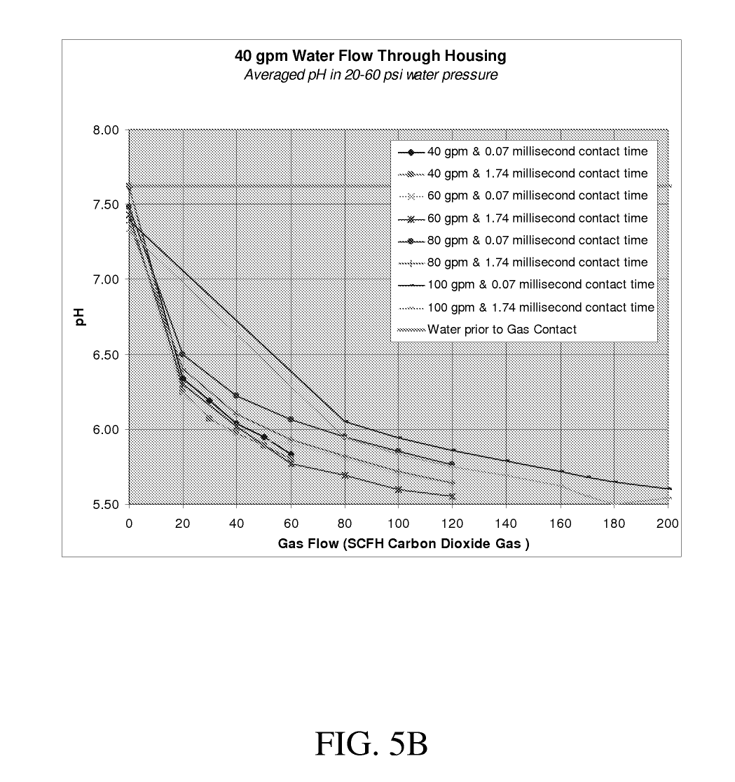

Applicants have conducted a series of experiments that compare the performance of apparatuses according to embodiments of the invention in which the carrier fluid flows along a parallel flow path with conventional apparatuses in which the carrier fluid flows along a tangential (perpendicular) flow path. As shown in FIG. 5A, the parallel flow path apparatus demonstrated the largest adjustment (lowering) in carrier fluid solution pH over the same range of carbon dioxide gas flow rates. Moreover, referring to FIGS. 5A and 5B, at a gas flow rate of 120 SCFH, the parallel flow path apparatus exhibited a lower carrier fluid solution pH (below 5.5) than the highest performing conventional perpendicular flow apparatus (above 5.5 with a 60 gpm carrier fluid flow rate and a 1.74 ms contact time).

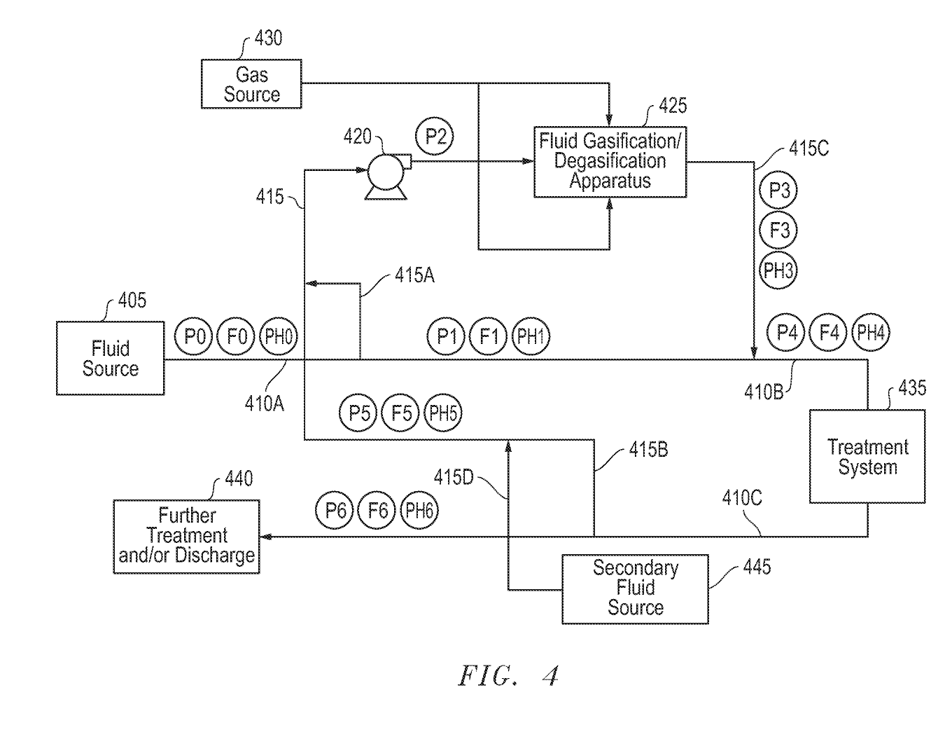

FIG. 3 is a flow chart illustrating a fluid gasification process in accordance with one or more embodiments of the invention. Those of ordinary skill in the art will appreciate that with slight modifications (as described previously herein) the process depicted in FIG. 3 can be used for fluid degasification.

In step S300, housing is provided. The housing may be, for example, housing in accordance with one or more embodiments of the invention described through reference to any of the previous Figures. In step S301, a membrane is provided or positioned within the housing. The membrane may be, for example, a membrane in accordance with one or more embodiments of the invention described through reference to any of the previous Figures.

In steps S302 and S303, at least one gas is supplied to the housing and ultimately to the membrane unit via one or more gas addition/removal apparatuses (such as those previously described through reference to FIGS. 2D-2E), each of which may be provided at either longitudinal end of the housing. The gas supplied in step S302 may be, for example, carbon dioxide; however, any suitable gas is within the scope of the invention. As described earlier through reference to FIGS. 2A-2E, gas may be supplied to the membrane unit via a hollow tubular structure provided as part of the gas addition/removal apparatus. In particular, gas may enter a cavity formed between an end cap of the housing and the membrane unit via diffusion through pores formed in the hollow tubular structure. The gas may then be distributed or distribute itself into the lumina of the hollow fiber membrane strands that make up the membrane unit.

In step S303, a carrier fluid may be supplied through an inlet of the housing at or above source pressure. As carrier fluid is being introduced to the housing, in step S304, a flow path for the carrier fluid is generated that facilitates mixing of the carrier fluid and gas that has diffused through pores formed in the outer shells of the membrane strands of the membrane unit. More specifically, an orientation of the inlet and outlet may result in a substantial portion of the carrier fluid traveling parallel to exterior surfaces of the membrane unit thereby facilitating interfacing between the carrier fluid and the diffused micro-bubbles of gas at or near the pore interface. Mixing and potential reaction of the carrier fluid and the gas generates a carrier fluid solution having the gas dissolved therein. In embodiments of the invention in which the gas is carbon dioxide and the carrier fluid is water, carbonic acid is formed at a very high reaction rate which in turn lowers the pH of the carbon dioxide/water solution.

In step S305, the carrier fluid that is formed in step S304, exits the housing through an outlet formed in the housing and may be combined with another fluid stream. In accordance with one or more embodiments of the invention, upon mixing of the carrier fluid solution and the fluid stream, the fluid stream may be chemically altered (e.g. a pH of the stream may be lowered). Alternatively, the gasified carrier fluid (i.e. the carrier fluid solution) may be used for any other suitable purpose.

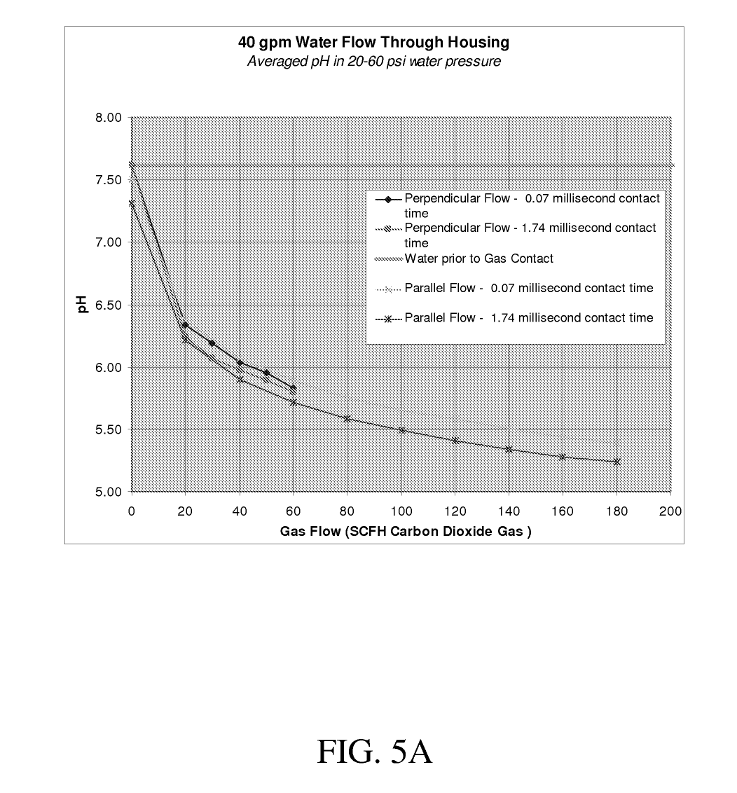

FIG. 4 depicts a system for fluid gasification/degasification similar to that depicted in FIG. 1B. FIG. 4 identifies the pressure, flow rate, and pHs of various fluid streams at various stages of the system/process flow of FIG. 1B. It should be noted that although FIG. 4 relates to those embodiments of the invention in which the gasified/degasified carrier fluid is used to alter the pH of a fluid stream, embodiments of the invention are not limited to pH adjustment. That is, the fluid gasification/degasification apparatuses according to embodiments of the invention may be used to alter chemical characteristics or properties of a fluid stream other than pH.

Referring to FIG. 4, fluid stream 410A generated from fluid source 405 has an initial pressure P0, an initial flow rate F0, and an initial pH (pH0). A side stream 415A may be diverted from the fluid stream 410A to form at least part of a carrier fluid 415. Side stream 415A has a pH (pH1) that is typically equivalent to the initial pH (pH0) of fluid stream 410A. That is, absent minor fluctuations in pH caused by changes to external conditions, pH0=pH1.

Carrier fluid 415 is supplied via pump 420 to fluid gasification/degasification apparatus 425. As part of a gasification process in apparatus 425, carrier fluid 415 mixes (and potentially reacts) with at least one gas supplied from gas source 430 to generate a carrier fluid solution 415C potentially having an adjusted pH. In particular, carrier fluid solution 415C may have a pH (pH3) that is less than pH0 (and by extension pH1). Solution 415C is then introduced into fluid stream 410A. Mixing of carrier fluid solution 415C and fluid stream 410A may result in an adjustment (e.g. lowering) of the pH of fluid stream 410A. In particular, introduction of carrier fluid solution 415C into fluid stream 410A generates fluid stream 410B having a pH (pH4) that may be lower than pH0, which is the initial pH of fluid stream 410A. However, pH4 is typically higher than pH3 due to the mixing of the lower pH solution 415C with fluid stream 410A having an initial pH of pH0=pH 1.

Fluid stream 410B having an adjusted pH of pH4 is then subjected to one or more treatment processes in treatment system 435 to generate fluid stream 410C having a pH (pH6) that may be slightly altered compared to pH4. A side stream 415B may be diverted from fluid stream 410C to form at least part of carrier fluid 415. Alternately, a secondary side stream 415D may be generated from a secondary fluid source 445 to form at least part of carrier fluid 415. Side stream 415B may have a pH (pH5) that is generally equivalent to the pH (pH6) of fluid stream 410C. However, both pH5 and pH6 may be slightly elevated compared to pH4 if gas mixing occurs during the treatment process of treatment system 435. Alternately, if secondary side stream 415D constitutes the primary component of carrier fluid 415, the pH of the secondary side stream 415D (pH5) may or may not differ from the pH (pH6) of fluid stream 410C.

Throughout the system/process flow depicted in FIG. 4, pH0=pH1 is generally in the range of about 6.0 to about 14.0. The pH of the carrier fluid solution 415C (pH3) may generally be in the range of about 2.0 to about 14.0. Further, pH4 which is generally equivalent to pH5 and pH6 (although, as noted above, pH5 and pH6 may be slightly elevated compared to pH4) is typically in the range of about 2.0 to about 14.0. It should be noted that the foregoing pH ranges are presented only by way of example and should not be deemed as limiting the pH values that any of the fluid streams may possess at any stage of the system/process flow of FIG. 5.

FIG. 4 also identifies the flow rates of the various fluid streams and side streams. The following discussion with respect to flow rates is based on the assumption that either side stream 415B alone (diverted from the fluid stream 410C) forms carrier fluid 415 or side stream 415A alone (diverted from fluid stream 410A) forms carrier fluid 415. However, it should be noted that this assumption is made solely to simplify the discussion with respect to variations in flow rates. For example, as shown in FIG. 4, a secondary side stream generated or diverted from a secondary fluid source 445 may be used to form at least part of carrier fluid 415. In accordance with one or more embodiments of the invention, side stream 415A, side stream 415B, and secondary side stream 415D may be combined in any proportion to form carrier fluid 415.

In the scenario in which side stream 415A alone forms carrier fluid 415, the flow rate F0 of fluid stream 410A generated from fluid source 405 is greater than the flow rate F1 of fluid stream 410A after side stream 415A is removed. Further, the flow rate F4 of fluid stream 410B (corresponding to fluid stream 410A after introduction of carrier fluid solution 415C) is generally equivalent to the initial flow rate F0 of fluid stream 410A and in turn is equivalent to the sum of flow rates F1 and F3. Further, because side stream 415B does not form part of the carrier fluid 415 in this scenario, its flow rate F5 is zero and the flow rate F6 of treated fluid stream 410C is generally equivalent to flow rate F4.

In the scenario in which the side stream 415B alone forms carrier fluid 415, the initial flow rate F0 of fluid stream 410A is generally equivalent to flow rate F1 because, in this scenario, side stream 415A does not form part of carrier fluid 415. Further, flow rate F3 of carrier fluid solution 415C is generally the same as flow rate F5 of side stream 415B that forms the carrier fluid 415. The flow rate F4 of fluid stream 410B (corresponding to fluid stream 410A after introduction of carrier fluid solution 415C) is generally equivalent to the sum of flow rates F0 and F5 of fluid stream 410A and side stream 415B, respectively. In this scenario, as side stream 415B is removed to form the carrier fluid 415, the flow rate F6 of fluid stream 410C is generally equivalent to the difference between flow rate F4 and flow rate F5 of treated side stream 415B.

FIG. 4 also identifies various pressures of fluid streams and side streams at different stages in the system/process flow. As similarly stated with respect to flow rates, the following discussion with respect to pressures is based on the assumption that either side stream 415B alone (diverted from fluid stream 410C) or side stream 415A alone (diverted from fluid stream 410A) forms carrier fluid 415. However, it should be noted that this assumption is made solely to simplify the discussion with respect to variations in pressures. For example, as shown in FIG. 4, a secondary side stream generated or diverted from a secondary fluid source 445 may be used to form at least part of carrier fluid 415. In accordance with one or more embodiments of the invention, side stream 415A, side stream 415B, and secondary side stream 415D may be combined in any proportion to form carrier fluid 415.

In the scenario in which side stream 415A alone forms carrier fluid 415, the pressure PO of fluid stream 410A generated from the fluid source 405 is generally equivalent to the pressure P1 of fluid stream 410A after side stream 415A has been removed, and is less than the pressure P2 at which carrier fluid 415 is pumped into apparatus 425. The pump 420 typically transfers the carrier fluid 415 into the apparatus 425 at a pressure P2 equivalent to an increase in the initial pressure PO by about 5 to about 20 psi. The pump 420 is employed in order to compensate for the pressure loss that occurs as the carrier fluid flows through the apparatus 425 as well as to ensure that the pressure P3 of the carrier fluid solution 415C is substantially equal to the pressure P1 of the fluid stream 410A prior to introduction therein. Further, the pressure P6 of fluid stream 410C having undergone the treatment process of treatment system 435 is typically less than pressure P4 as a result of a pressure drop that occurs across the treatment system 435.

In the scenario in which side stream 415B alone forms carrier fluid 415, the pressure PO of fluid stream 410A generated from fluid source 405 is generally equivalent to pressure P1, and is less than the pressure P2 at which the carrier fluid 415 is pumped into apparatus 425. The pump 420 typically transfers the carrier fluid 415 into the apparatus 425 at a pressure P2 equivalent to an increase in the pressure P5 of side stream 415B by about 5 to about 20 psi. The pump 420 is employed in order to compensate for the pressure loss that occurs as the carrier fluid flows through the apparatus 425 as well as to ensure that the pressure P3 of the carrier fluid solution 415C exceeds the pressure P1 of fluid stream 410A prior to introduction of the solution 415C into the fluid stream 410A. In addition, the pressure P3 of the carrier fluid solution 415C is generally less than the pressure P2 of the carrier fluid 415 prior to introduction into the apparatus 425 due to a pressure drop that occurs across the apparatus 425. Further, the pressure P6 of fluid stream 410C as well as the pressure P5 of side stream 415B both may be less than pressure P4 due a pressure drop that occurs across the treatment system 435.

FIG. 4 has been provided to describe variations in pH, flow rate, and pressure that occur during a pH adjustment process in accordance with embodiments of the invention. It should be understood that although not explicitly shown in FIG. 4, the gas dosing system and control system described through reference to FIGS. 1A and 1B also form part of the system depicted in FIG. 4.

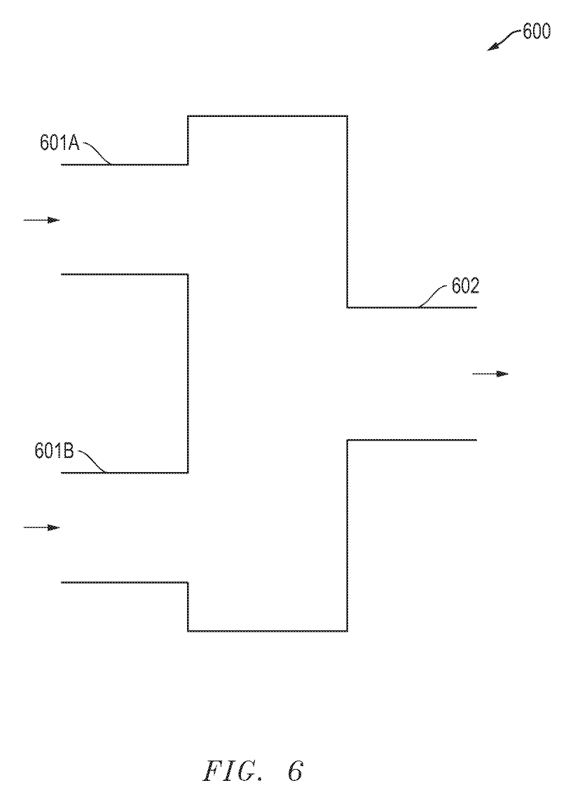

FIG. 6 schematically depicts a fluid gasification/degasification apparatus in accordance with one or more alternative embodiments of the invention. The apparatus 600 includes two fluid inlets 601A, 601B and a single fluid outlet 602. It should be noted, however, that fluid gasification/degasification apparatuses in accordance with embodiments of the invention may include any number of fluid inlets and/or fluid outlets. By virtue of having two fluid inlets 601A, 601B, the apparatus 600 is capable of sustaining increased carrier fluid flow, which in turn decreases the amount of contact/interface time between the carrier fluid and the diffused gas necessary in order to achieve a desired chemical alteration (e.g. a desired adjusted pH).

While the invention has been described with respect to certain embodiments of the invention, other and further embodiments of the invention may be devised without departing from the spirit and scope of the invention. As such, the scope of the invention is determined by the claims that follow. The invention is not limited to the particularly described embodiments, versions or examples, which are included to enable a person having ordinary skill in the art to make and use the invention when combined with information and knowledge available to the person having ordinary skill in the art.

What is claimed is:

1. A process for chemically altering a first fluid stream, the process comprising:
providing at least one fluid gasification/degasification apparatus comprising:
housing comprising at least one fluid inlet, at least one fluid outlet, and a vertically aligned central axis that extends between a top portion and a bottom portion of the housing, the at least one fluid inlet and the at least one fluid outlet positioned at different axial locations along the housing,
a membrane unit disposed within the housing and comprising a plurality of bundled microporous hollow fiber membrane strands extending parallel to the central axis of the housing, each membrane strand comprising an outer shell having an inner diameter defining a lumen, the outer shell having a plurality of pores formed therein, and
one or more gas addition/removal apparatuses for facilitating at least one of: a gas addition operation and a gas removal operation;
diverting at least a portion of the first fluid stream as a first side stream;
introducing the first side stream to the at least one fluid gasification/degasification apparatus, wherein a fluid pressure of the first side stream is increased to compensate for a pressure drop that occurs as the first side stream passes through the at least one fluid gasification/degasification apparatus;
facilitating at least one of: the gas addition operation and the gas removal operation to generate a chemically altered first side stream, wherein during the gas addition operation, the first side stream interfaces at or near at least one of the plurality of pores with micro-bubbles of a gas supplied to the membrane unit, and an orientation of the at least one fluid inlet and the at least one fluid outlet results in a substantial portion of the first side stream traveling parallel to exterior surfaces of the membrane unit thereby allowing for an extended interface time between the first side stream and the micro-bubbles of the supplied gas; and
introducing the chemically altered first side stream into the first fluid stream to generate a chemically altered first fluid stream, the chemically altered first side stream having a fluid pressure substantially equal to a fluid pressure of the first fluid stream.

2. The process of claim 1, each gas addition/removal apparatus comprising a microporous hollow tubular structure comprising an outer shell having a plurality of pores formed therein and an inner diameter defining a lumen, the hollow tubular structure extending into the housing and through a cavity formed between an end cap of the housing and an upper surface of the membrane unit, the hollow tubular structure further extending into at least a portion of the membrane unit.

3. The process of claim 2, the gas addition operation comprising:
introducing the supplied gas at a specified pressure into the hollow tubular structure, the supplied gas undergoing a distribution stage and a diffusion stage upon introduction to the hollow tubular structure,
wherein,
during the distribution stage, the supplied gas diffuses from a lumen side of the hollow tubular structure into the cavity through at least one of the plurality of pores formed in the outer shell of the hollow tubular structure, and moves therefrom into the lumen of at least one membrane strand of the membrane unit, and
during the diffusion stage, the micro-bubbles of the supplied gas diffuse from a lumen side to a shell side of the at least one membrane strand through at least one pore formed in an outer shell thereof and interface with the first side stream to generate the chemically altered first side stream; and
the gas removal operation comprising at least one of:
generating a pressure differential between the lumen side and the shell side of at least one membrane strand of the membrane unit, thereby lowering a partial pressure of a gas dissolved in the first side stream and facilitating mass transfer of the dissolved gas from the first side stream to generate the chemically altered first side stream, and
supplying an inert gas to the lumen of the at least one membrane strand of the membrane unit, thereby generating a concentration gradient of the dissolved gas between the lumen side and the shell side of the at least one membrane strand and facilitating mass transfer of the dissolved gas from the first side stream to generate the chemically altered first side stream.

4. The process of claim 1, wherein a surface area to volume ratio of the micro-bubbles of the supplied gas facilitates interfacing of the micro-bubbles and the first side stream and chemical alteration of the first side stream.

5. The process of claim 1, further comprising:
diverting at least a portion of a second fluid stream as a second side stream;
combining the second side stream with first side stream to form a combined side stream;
introducing the combined side stream to the at least one gasification/degasification apparatus, wherein a fluid pressure of the combined side stream is increased to compensate for a pressure drop that occurs as the combined side stream passes through the at least one fluid gasification/degasification apparatus;
facilitating at least one of: the gas addition operation and the gas removal operation to generate a chemically altered combined side stream; and
introducing the chemically altered combined side stream into the first fluid stream to generate the chemically altered first fluid stream, the chemically altered combined side stream having a fluid pressure substantially equal to the fluid pressure of the first fluid stream.

6. The process of claim 5, wherein the second fluid stream is generated from a secondary fluid source that is separate from a first fluid source from which the first fluid stream is generated.

7. The process of claim 5, wherein the second fluid stream corresponds to the chemically altered first fluid stream after treatment with one or more treatment processes.

8. The process of claim 1, wherein each of the supplied gas and the dissolved gas comprises at least one of: carbon dioxide, oxygen and hydrogen.

9. The process of claim 1, wherein an adjusted pH of the chemically altered first fluid stream is in the range of about 2.0 to about 14.0.

10. The process of claim 1, wherein an interface time between the first side stream and the micro-bubbles of the supplied gas is specified based on a desired chemical alteration of the first fluid stream.

11. The process of claim 3, further comprising:
inputting one or more process parameters to a system controller via a user interface,
the system controller analyzing the inputted process parameters to determine an initial mass flow rate for at least one of: the supplied gas and the inert gas, the system controller communicating the determined initial mass flow rate to at least one mass flow valve that controls introduction of at least one of: the supplied gas and the inert gas to the one or more gas addition/removal apparatuses based on the communicated initial mass flow rate.

12. The process of claim 11, further comprising:
measuring a pH of the chemically altered first fluid stream; and
communicating the measured pH to the system controller which adjusts the initial mass flow rate of at least one of: the supplied gas and the inert gas based on the measured pH in order to achieve a desired pH for the chemically altered first fluid stream.

13. The process of claim 12, wherein the pH of the chemically altered first fluid stream is measured after treatment of the chemically altered first fluid stream with one or more treatment processes.

14. A fluid gasification/degasification apparatus comprising:
housing comprising at least one fluid inlet, at least one fluid outlet, and a vertically aligned central axis that extends between a top portion and a bottom portion of the housing, the at least one fluid inlet and the at least one fluid outlet positioned at different axial positions along the housing;
a membrane unit disposed within the housing and comprising a plurality of bundled microporous hollow fiber membrane strands extending parallel to the central axis of the housing, each membrane strand comprising an outer shell having an inner diameter defining a lumen, the outer shell having a plurality of pores formed therein; and
one or more gas addition/removal apparatuses, each being provided at or near the top portion or the bottom portion of the housing for facilitating at least one of a gas addition operation and a gas removal operation,
wherein:
during the gas addition operation, a carrier fluid supplied to the housing interfaces at or near at least one of the plurality of pores with micro-bubbles of a gas supplied to the membrane unit, and
an orientation of the at least one fluid inlet and the at least one fluid outlet results in a substantial portion of the carrier fluid traveling parallel to exterior surfaces of the membrane unit thereby allowing for an extended interface time between the carrier fluid and the micro-bubbles of the supplied gas; and
each gas addition/removal apparatus comprising:
a microporous hollow tubular structure comprising an outer shell having a plurality of pores formed therein and an inner diameter defining a lumen, the hollow tubular structure extending into the housing and through a cavity formed between an end cap of the housing and an upper surface of the membrane unit, the hollow tubular structure further extending into at least a portion of the membrane unit.

15. The fluid gasification/degasification apparatus of claim 14, the gas addition operation comprising:
introducing the supplied gas at a specified pressure into the hollow tubular structure, the supplied gas undergoing a distribution stage and a diffusion stage upon introduction to the hollow tubular structure,
wherein,
during the distribution stage, the supplied gas diffuses from a lumen side of the hollow tubular structure into the cavity through at least one of the plurality of pores formed in the outer shell of the hollow tubular structure, and moves therefrom into the lumen of at least one membrane strand of the membrane unit, and
during the diffusion stage, the micro-bubbles of the supplied gas diffuse from a lumen side to a shell side of the at least one membrane strand through at least one pore formed in an outer shell thereof and interface with the carrier fluid to generate a chemically altered carrier fluid; and
the gas removal operation comprising at least one of:
generating a pressure differential between the lumen side and the shell side of at least one membrane strand of the membrane unit, thereby lowering a partial pressure of a gas dissolved in the first side stream and facilitating mass transfer of the dissolved gas from the carrier fluid to generate a chemically altered carrier fluid, and
supplying an inert gas to the lumen of the at least one membrane strand of the membrane unit, thereby generating a concentration gradient of the dissolved gas between the lumen side and the shell side of the at least one membrane strand and facilitating mass transfer of the dissolved gas from the carrier fluid to generate a chemically altered carrier fluid.

16. The fluid gasification/degasification apparatus of claim 15, wherein an amount of the dissolved gas in the chemically altered carrier fluid solution is less than an amount that would yield a super-saturated solution.

17. A system for chemical alteration of a fluid stream, the system comprising:
one or more fluid gasification/degasification apparatuses according to claim 15;
a gas transport and dosing system for transporting at least one of: the supplied gas and the inert gas from one or more storage receptacles to the one or more gas addition/removal apparatuses of each of the one or more fluid gasification/degasification apparatuses; and
a control system for controlling a mass flow rate of at least one of: the supplied gas and the inert gas into the one or more gas distribution/removal apparatuses of each of the one or more fluid gasification/degasification apparatuses in dependence on one or more process parameters,
wherein the chemically altered carrier fluid solution is combined with the fluid stream to generate a chemically altered fluid stream.

18. The system of claim 17, the control system comprising:
a user interface for inputting the one or more process parameters;
a system controller that analyzes the inputted parameters to determine an initial mass flow rate for at least one of: the supplied gas and the inert gas,
one or more mass flow metering instruments for measuring a mass flow rate of at least one of: the supplied gas and the inert gas; and
a chemical analyzer for measuring a chemical alteration of the chemically altered fluid stream,
wherein:
the system controller communicates the determined initial mass flow rate to at least one mass flow valve provided as part of the gas transport and dosing system, which controls introduction of at least one of: the supplied gas and the inert gas into the one or more gas distribution/removal apparatuses of each of the one or more fluid gasification/degasification apparatuses based on the communicated initial mass flow rate, and
the system controller adjusts the initial mass flow rate based on at least one of: the measured chemical alteration communicated by the chemical analyzer and the measured mass flow rate in order to achieve a desired chemical alteration for the chemically altered fluid stream.

19. The system of claim 18, further comprising:
one or more treatment systems that subject the chemically altered fluid stream to one or more treatment processes.

20. The system of claim 19, wherein the chemical analyzer is disposed downstream from the one or more treatment systems.
